(19) United States
(12) Patent Application Publication
(10) Pub. No.: US 2007/0213088 A1
(43) Pub. Date: Sep. 13, 2007

(54) NETWORKED FIRE STATION MANAGEMENT

(75) Inventor: Gregory A. Sink, Frankfort, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: FEDERAL SIGNAL CORPORATION, Oakbrook, IL (US)

(21) Appl. No.: 11/677,486

(22) Filed: Feb. 21, 2007

Related U.S. Application Data
(63) Continuation-in-part of application No. 11/548,209, filed on Oct. 10, 2006.
(63) Continuation-in-part of application No. 11/558,802, filed on Nov. 10, 2006.
(63) Continuation-in-part of application No. 11/505,642, filed on Aug. 17, 2006.
(60) Provisional application No. 60/775,634, filed on Feb. 22, 2006.

(51) Int. Cl. H04Q 7/20; H04B 7/00

(52) U.S. Cl. 455/524

(57) ABSTRACT

A communications system for one or more of a community's public safety resources is upgraded to include a public safety network. Assets owned by one of the public safety resources may be controlled over the network from a remote command center that compiles information from the network-enabled resources in the community to enhance the ability of the assets to effectively deployed in an emergency situation. The upgraded communications system at the public safety resources also enables trusted resources, such as the assets owned by the public safety resources, to access the network and communicate with additional trusted resources throughout the community. Additionally, the public safety network may be extended using mobile transceivers to form an ad hoc network in the event part of the infrastructure supporting the network is lost.

### CROSS-REFERENCE TO RELATED APPLICATIONS

Pursuant to 35 U.S.C. § 119, this patent application claims the benefit of U.S. provisional patent application No. 60/775,634, filed Feb. 22, 2006. This patent application is a continuation-in-part of co-pending U.S. patent application Ser. No. 11/548,209, filed Oct. 10, 2006, Ser. No. 11/558,802, filed Nov. 10, 2006, and Ser. No. 11/505,642, filed Aug. 17, 2006. This application is also related to co-pending U.S. patent application no. <Atty Dkt. No. 701112>, filed Feb. 21, 2007 and entitled “Public Safety Warning Network,” naming Greg Sink as the inventor. Each of these applications is hereby incorporated by reference in its entirety and for everything it describes.

### BACKGROUND OF THE INVENTION

Communities deploy specialized systems and networks to respond to emergency situations. For example, emergency call centers receive incoming calls related to emergencies and transmit the emergency information to appropriate agencies, such as fire departments and police departments. As the call center receives a call, an operator records vital information related to the emergency. For example, the type of emergency, location of the emergency, number of people involved and other vital information is recorded. The attendant must transmit this information over a network to the appropriate authorities. Currently, there is no uniform method of transmitting the vital information. Telephone calls, pager alerts, emails, and other means are utilized to alert the proper authorities to the situation. Thus, a community relies on a number of public and private networks to alert authorities of an emergency.

Communities deploy numerous additional systems and networks to monitor and respond to local conditions and emergencies. For example, many communities deploy outdoor warning sirens to warn citizens of impending dangers, such as tornados. Supervisory Control and Data Acquisition (SCADA) systems monitor and control various functions throughout a community. For example, community warning sirens, municipal water supplies, electric power generation and distribution, gas and oil pipelines, flood control systems, cellular telephone base stations and various other public service resources are monitored using SCADA systems. Each SCADA system requires its own network. For example, a community Public Works Department monitors and manages the municipal water supply through one dedicated network. A separate SCADA network is used to monitor electric power generation and the electric distribution network. Additional networks monitor a community's gas and oil pipelines.

A community's emergency services personnel deploy additional networks to monitor and respond to events in the community. For example, police departments, fire departments and other emergency responders rely on dedicated point-to-point and point-to-multipoint communications systems operating at various frequencies including frequencies in the VHF and UHF bands. Increasingly, communities are deploying communications systems operating in the regulated 4.9 GHz public safety band. Many communities deploy systems of distributed cameras to monitor and deter crime. The camera systems operate on yet another separate, dedicated network. In addition, emergency service personnel increasingly rely on broadband networks to transmit data and voice. Broadband networks facilitate communicating multiple types of data and allow multiple users to access the system. One example of a broadband network is wireless fidelity (Wi-Fi) networks based on the Institute of Electrical and Electronics Engineers (IEEE) 802.11 specification. However, other networks such as cellular networks are also used.

The integrity and reliability of many of these public service networks are critical in emergencies. Typically, these systems rely on the community's power grid. If the grid fails either partially or completely in an emergency, then the public service networks must rely on sources of back up or auxiliary power to maintain operation. Some public service networks, such as outdoor warning siren systems, provide a battery backup at each siren installation in case of failure of the power grid. However, some systems do not include redundant power supplies. If an emergency compromises a community's power grid, emergency services without auxiliary power are also compromised. In distributed systems, adding auxiliary power can be expensive.

Regardless of whether auxiliary power is available, managing, installing and servicing all of the separate systems in a community are time intensive and expensive undertakings. The networks are not interconnected and do not share data. Service personnel must travel to each end node and install, maintain or upgrade network equipment. Locating an appropriate site to mount networking nodes is difficult. To provide maximum coverage, nodes must be elevated above ground level and power must be provided at each site. Within each of the networks, this process is highly redundant. However, from one network to another the servicing can be quite different and require different training and skills.

Recently, municipalities have begun to support public wireless internet access by deploying Wi-Fi based access points. Although these systems are aimed at the public access 2.4 GHz bandwidth, they may also support the regulated public safety 4.9 GHz bandwidth as well as other unregulated bandwidths such as 5.8 GHz. Municipalities partner with private businesses to deploy Wi-Fi systems throughout a community. The systems are typically deployed in a mesh network configuration in order to provide public access at 2.4 GHz. Typically, a community requires an average of 28 Wi-Fi access points per square mile in order to provide complete Wi-Fi coverage. Deploying the systems requires a substantial initial investment that municipalities often finance by partnering with private business who assume much of the installation and equipment expenses in order to derive revenue from ongoing operations of the Wi-Fi network. This strategy has been effective for large municipalities but may prove problematic for smaller communities that do not have a sufficiently large population to attract investment from private industry.

### BRIEF SUMMARY OF THE INVENTION

The invention provides methods of installing a community-wide emergency response network and includes methods for installing a combination of public safety networks, public access networks and backhaul networks. Initially, an existing emergency response center is selected for upgrading. Example centers include fire stations and police stations. However, additional resources such as outdoor warning sirens, water resource monitoring systems and other SCADA systems can be upgraded. After a system is selected for upgrading, transceivers are installed for a public safety network and a backhaul network. The Federal Communications Commission (FCC) reserved the 4.9 GHz frequency spectrum for use by community emergency service personnel, although other frequencies can be used. Backhaul transceivers operate at various frequencies. One embodiment uses the IEEE 802.11a specification to implement the backhaul transceiver operating at 5.8 GHz. If the community-based assets already contain appropriate public safety or backhaul transceivers, those transceivers do not need to be installed.

After installing the public safety transceivers and backhaul transceivers it is determined whether there exists sufficient public safety network coverage. Sufficient public safety network coverage varies with the needs of a particular community. For example, one community may choose to provide ubiquitous coverage over the entire community. In this way, first responders may utilize the network in order to better respond to emergencies. Some communities may not need complete coverage for the public safety network. For example, some communities may only provide high density downtown areas with coverage, while more rural areas of the same community may not need public safety network coverage. If the coverage is not sufficient for a particular community, the coverage is extended. Typically, a community extends network coverage by adding additional nodes to the network.

An automation module can be installed at the emergency response center. For example, a fire station may install modules to automatically perform a number of routine functions when an emergency alert is received. Example routine functions that can be automated include opening the station's bay doors, turning on exhaust fans, sounding an audible alarm to alert fire fights, turning on room lighting, displaying pertinent information on a terminal in the fire station and send information to a local printer. Traffic lights outside the fire station can also be part of the automation in order to clear traffic in the path of fire equipment heading to a site of an emergency. In other public safety environments, automation modules may be installed to control functionality of other types of local resources and assets. For example, Supervisory Control And Data Acquisition (SCADA) systems such as a system for monitoring and controlling a municipal water supply can be upgraded to include automation modules. These modules include control systems at the SCADA site that automatically react to commands delivered over the network connection. An outdoor warning siren can be upgraded to include control systems that may, for example, automatically monitor and report battery life and react to commands delivered over the network—e.g, run self-diagnostics and report results. Security gates can be automated by a network connection to react to emergency situations detected at other network nodes in order to secure vulnerable areas or open them for quick evacuation. Flood control and monitoring systems can be integrated into the public safety network to inform other public safety systems and devices of dangerous flooding conditions and to automatically respond to commands from a central control station that integrated information from various public safety devices and systems to synthesize commands for the flood control and monitoring system and other public safety device and systems in the community. Alarm monitoring for businesses, municipal buildings and schools can be integrated into the public safety network to inform police and fire of burglary or fire condition to improve response time and help reduce the loss of life and property. Additional traffic control devices can be added to traffic lights within a municipality to control the traffic lights to improve traffic flow for responding emergency vehicles or ingress and egress for major events held within a municipality. Meteorological weather stations can be integrated into the public safety network to monitor the wind speed and direction for creating plume model tracking of harmful chemical or biochemical threats. Likewise, chemical, radiological and biological sensors distributed in a community can be network enabled and include controls that respond automatically to commands from a remote control center.

A community may also install a public access network. The public access network is based on any appropriate network protocol. One example public access network protocol is Wi-Fi based on the IEEE 802.11 specification, although other network protocols and specifications can be used. After installing the public access transceivers, a community determines whether there is sufficient public access coverage. Some communities may provide ubiquitous public access network coverage. However, some communities may only provide public network coverage in densely populated areas. If additional coverage is needed, coverage is extended by adding additional transceivers until the public access network coverage is sufficient.

After a community response center's communications infrastructure has been upgraded to support a community wide, wireless network, the network may be accessed by additional community resources. For example, mobile communication devices used by community trusted personnel such as police officers can access the network. Fire trucks, parking control devices and police vehicles can all access the public safety network. Data on the public safety network can be routed to a backhaul. The backhaul can route the data to the internet or to a community control center. The control center can be used to coordinate a community's emergency response and monitoring systems and to monitor community resources. Additionally, devices and systems connected to the network can communicate and control one another. For example, a fire truck connected to the network can sound an outdoor warning siren to warn citizens of an emergency. Additionally if a chemical, radiological and biological sensors detects a threat it can use the data from a meteorological weather station to identify areas at risk in a community and only activate outdoor warning sirens in the area at risk and at the same time control the traffic lights to allow a safer/faster egress from the community to allow those affected to get out of harms way.

If an event destroys all or part of a community's network infrastructure, first responders and other trusted resources can continue to communicate with the control center by forming an ad hoc network with at least one node in the ad hoc network also connecting to the community wide network or directly to the control center. Additionally, if an event occurs beyond the range of the community wide network, an ad hoc network can be established to extend the range of the community wide network so that the network reaches the emergency. For example, police cars may form an ad hoc network to patch a whole in the community wide network. In this example, the ad hoc network formed by the police vehicles allows other trusted resources to access the network. For example, a police officer may use a handheld device to connect to the community wide network through the ad hoc network established by police vehicles.

The networking methods and systems according to various embodiments incorporate other features and advantages that will be more fully appreciated from the following description in conjunction with the accompanying figures.

### BRIEF DESCRIPTION OF THE SEVERAL VIEWS OF THE DRAWING(S)

FIG. 1 illustrates a community emergency response system including a control center, fire station and emergency response vehicle;

FIG. 2 is a flowchart illustrating one embodiment of a process for upgrading the community emergency response system of FIG. 1 to support a backhaul, public safety communications, public Wi-Fi access and local automation activities;

FIG. 3 illustrates the community emergency response system of FIG. 1 whose communications infrastructure has been upgraded in keeping with the process of FIG. 2 to support a community wide, wireless network that is accessible by additional community resources;

FIG. 4 illustrates SCADA community warning systems whose infrastructures have been upgraded to provide a community-wide, wireless network in keeping with the process illustrated in FIG. 3;

FIG. 5 illustrates typical community resources and public access devices that may connect to the community-wide, wireless networks of FIG. 4;

FIG. 6 illustrates one embodiment of a network upgrade module that is retrofitted to upgrade the installed base of the community emergency response system of FIGS. 1 and 3;

FIG. 7 illustrates another embodiment of a network upgrade module having a Wi-Fi transceiver, a public safety network transceiver and a back-haul transceiver for retrofitting an installed base of community assets such as the community emergency response system of FIGS. 1 and 3 and the SCADA community warning system of FIG. 4;

FIG. 8 illustrates various backhaul deployments in the community-wide, wireless network systems illustrated in FIGS. 3, 4 and 5; and

FIG. 9 illustrates a mobile ad hoc network normally supported by the community-wide, wireless network systems illustrated in FIGS. 3, 4 and 5 that effectively patches holes in the network in the event that part of the infrastructure supporting the community-wide, wireless network is lost.

### DETAILED DESCRIPTION OF THE INVENTION

The following description is intended to convey the operation of exemplary embodiments of the invention. It will be appreciated that this description is intended to aid the reader, not to limit the invention. As such, references to a feature or aspect of the invention are intended to describe a feature or aspect of an embodiment of the invention, not to imply that every embodiment of the invention must have the described characteristic.

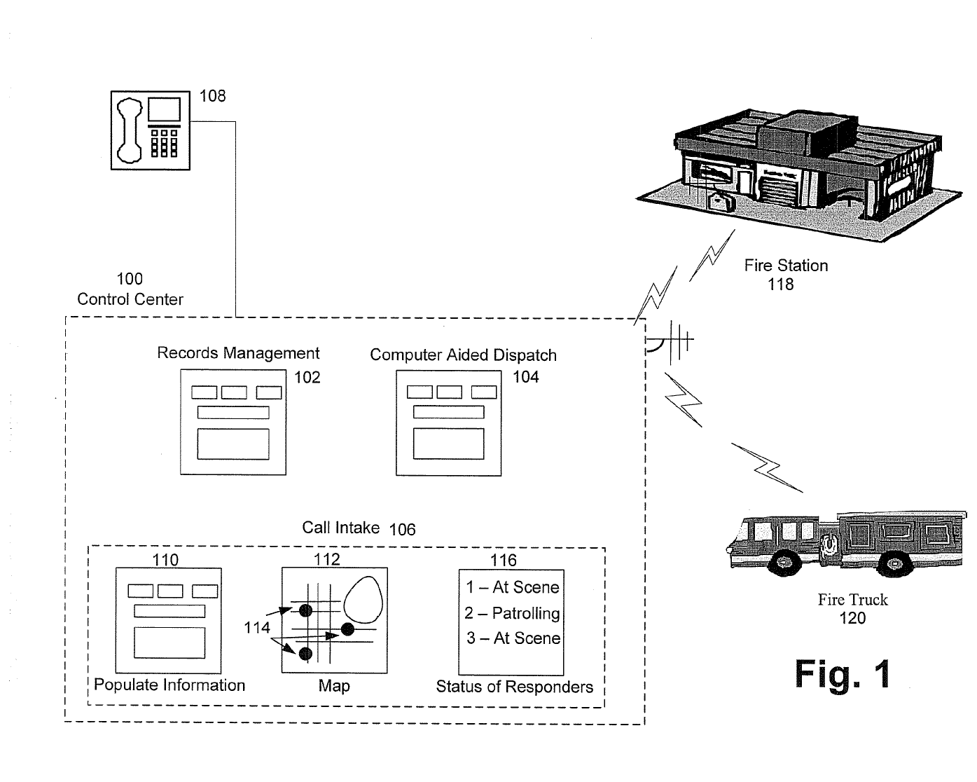

Many governmental and non-governmental agencies deploy networks throughout a community. For example, communities deploy various networks to receive information related to emergencies and to transmit relevant emergency information to police and fire departments. Many communities deploy outdoor warning sirens to warn citizens of impending dangers, such as tornados. Additionally, communities typically have a variety of assets distributed throughout a community. For example, police stations, fire stations, a town hall, libraries, fire trucks, ambulances, police cars, street sweepers and various other assets are distributed throughout a community. FIG. 1 illustrates a community emergency response system including a communications infrastructure and community assets in keeping with existing installations. The control center 100 includes a records management module 102, computer aided dispatch module 104 and call intake module 106. The control center 100 receives alerts regarding emergencies from various sources. For example, a person can call the control center 100 using a telephone 108 to report an emergency. Additionally, the command center receives weather alerts from the National Weather Service, meteorological monitoring stations and storm spotters. Alerts are received through either automated or manual means.

After receiving an alert, the command center 100 logs vital information related to the emergency using the call intake module 106. A populate information terminal 110 allows an operator to electronically record information. A map terminal 112 displays a map of the community and the location of relevant emergency response personnel and vehicles 114. The status of responders terminal 116 displays the current status of relevant emergency response personnel, such as those shown on the map terminal 112. After recording the necessary information in the populate information terminal 110, an operator alerts relevant departments or first responders of the emergency. For example, if an alert related to a fire is received, the control center 100 alerts fire station 118 and fire truck 120. The location of fire truck 120 is shown on map terminal 112. Additionally, status of responders terminal 116 displays the current status of fire truck 120. After receiving the alert, fire station 118 can send additional emergency vehicles and personnel into the field. In order to deploy the additional resources, fire station 118 must accomplish a number of routine tasks. The location and type of emergency must be received from the control center 100. An audible alarm must be sounded to alert personnel within the station 118 to the emergency. Exhaust fans in the fire truck garage must be activated and the garage bay doors must be opened. Inside lights can be turned on to allow fire fighters to see at night, exterior traffic lights or emergency warning lights can be turned on at the road to let approaching vehicles know an emergency vehicle is exiting the fire station. These functions are routine, but critical to responding to an emergency. Messages from the control center 100 are transmitted to the fire station 118 and fire truck 120 using specialized, dedicated networks.

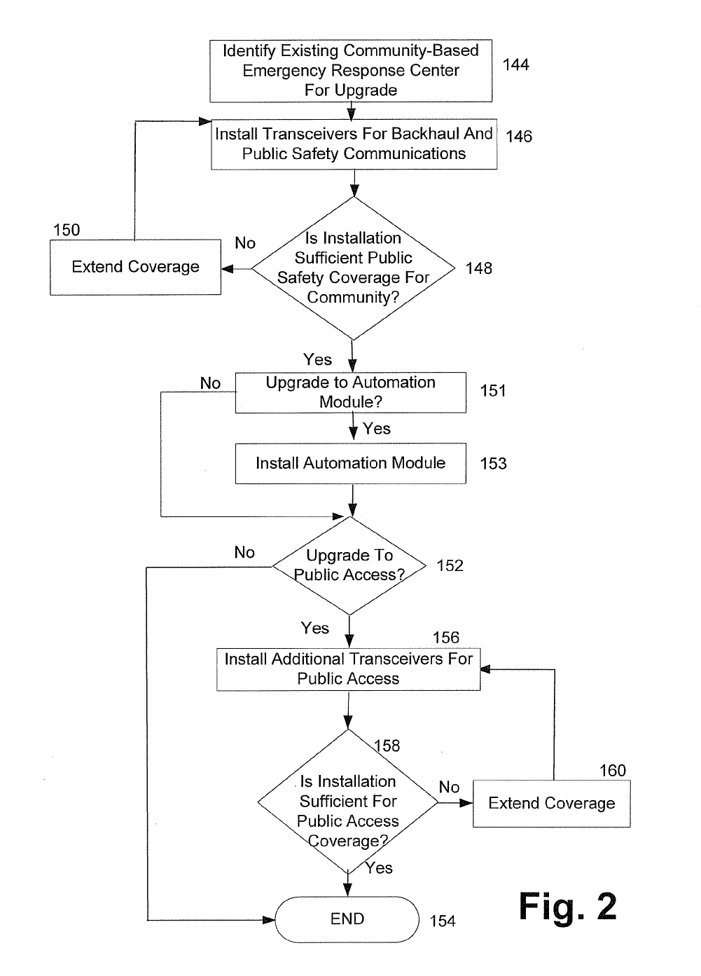

FIG. 2 illustrates one method of implementing a wireless community based network system in keeping with one embodiment of the invention. The upgrade process begins at step 144 where an existing community-based emergency response system is identified. Example emergency response systems include the fire station illustrated in FIG. 1, police stations and other community assets. The method illustrated in FIG. 2 can be applied to various community based assets such as SCADA systems. Copending U.S. application entitled “Public Safety Warning Network,” serial no. <Atty Dkt. No. 701112> filed Feb. 21, 2007 naming Greg Sink as the inventor, which is hereby incorporated by reference in its entirety and for everything that it describes, illustrates methods of upgrading various community systems including outdoor warning sirens.

The process of upgrading an existing system includes replacing part or all of the community-based system. An exemplary existing community based response system is the fire station illustrated in FIG. 1. After identifying the existing system to upgrade at step 144, transceivers are installed for a public safety network and a backhaul network. Alternatively, the existing system can be upgraded by replacing it with a new system containing the transceivers. For example, during the process of upgrading the fire station system illustrated in FIG. 1, some communities may upgrade the existing station 118 by replacing the existing station with new a new station containing public safety transceivers. The existing community-based response system can alternatively be a local warning system, such as a system of fire waning devices such as smoke detectors or fire sirens located within a building. Thus, the indoor warning system is upgraded to include transceivers.

The Federal Communications Commission (FCC) has reserved the 4.9 GHz frequency spectrum for use by community emergency service personnel. In one embodiment of the invention, the public safety transceiver installed at step 146 operates in the 4.9 GHz spectrum, although other frequencies can also be used. Backhaul transceivers can operate at various frequencies. One embodiment uses the IEEE 802.11a specification to implement the backhaul transceiver operating at 5.8 GHz. If the community based assets identified in step 144 already contain appropriate public safety or backhaul transceivers, those transceivers do not need to be installed at step 146.

In some embodiments of the invention, implementing a public safety network reduces the number of dedicated single purpose networks. For example, the response system of FIG. 1 may operate on the common public safety network rather than on a dedicated network. Certain additional SCADA and public safety systems can be converted to operate on the 4.9 GHz public safety network rather than on individual, dedicated networks.

After installing the public safety transceiver and backhaul transceiver at step 146, at step 148 it is determined whether there exists sufficient public safety network coverage. Sufficient public safety network coverage varies with the needs of a particular community. For example, one community may choose to provide ubiquitous coverage over the entire community. In this way, first responders may utilize the network in order to better respond to emergencies. Some communities may not need complete coverage for the public safety network. For example, some communities may only provide high density downtown areas with coverage, while more rural areas of the same community may not need public safety network coverage.

If the coverage is not sufficient for a particular community, the coverage is extended at step 150. Typically, a community extends network coverage by adding additional nodes to the network at step 146. After the public safety network has sufficient coverage, step 151 decides whether the emergency response system should be upgraded to include certain automated features. Automation modules are installed at step 153. For example, the fire station 118 (FIG. 1) may be upgraded such that when a call is received at the control center 100 and transmitted to the fire station 118 certain routine functions occur automatically. An audible alarm can be automatically sounded to alert personnel within the station 118 to the emergency. Exhaust fans in the fire truck garage automatically start and the garage bay doors automatically open, interior lights can be turned on, external emergency lights can be activated to alert traffic of an exiting fire truck. By automating routine functions, the emergency responders can depart the fire station 118 quickly and respond the emergency faster.

If the public safety network coverage is sufficient and the optional automation modules are installed at step 153, a community determines whether to provide public network access at step 152. If a community does not provide public network access, the method ends at step 154. If the community does install a public access network, additional public access transceivers are installed at step 156. The public access network is based on any appropriate network protocol. One example public access network protocol is Wi-Fi based on the IEEE 802.11 specification, although other network protocols and specifications can be used. Additional examples of appropriate protocols include any IEEE 802.11 protocol such as IEEE 802.11a, 802.11b, 802.11 g or 802.11n, Wi-Max and WiBro, both based on the IEEE 802.16 standard, and Hiperman based on the European Telecommunications Standards Institute protocol.

After installing the public access transceivers, a determination is made at step 158 whether there is sufficient public access coverage. Some communities may provide ubiquitous public access network coverage. However, some communities may only provide public network coverage in densely populated areas. If additional coverage is needed, coverage is extended at step 160 by adding additional transceivers at step 156. When sufficient public access coverage exists, the upgrade process ends at step 154. Communities can implement various procedures for allowing access to the public access networks. For example, public access can be provided at no cost to end users. However, public access networks can also be limited to those who subscribe to the service or agree to view certain advertising. Communities may choose to collaborate with private companies to manage access to the networks. Additionally, communities may provide access to sites for installation of the networking equipment and private companies or governmental agencies may perform the network installation and/or manage the public access networks.

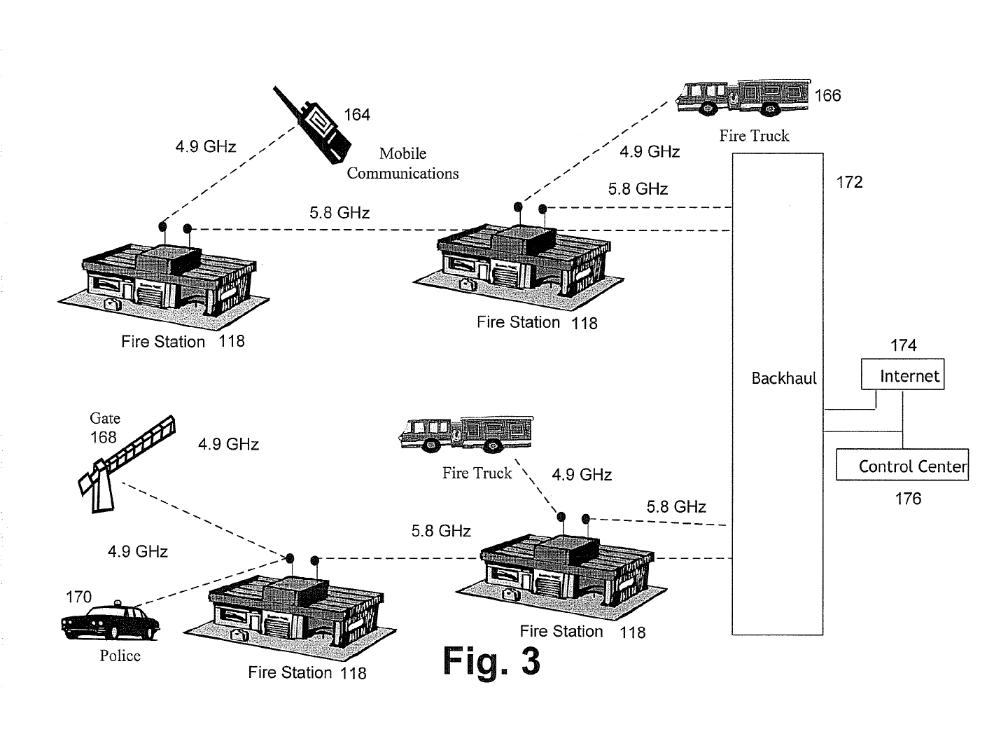

FIG. 3 illustrates the community response system of FIG. 1 whose communications infrastructure has been upgraded in keeping with the process of FIG. 2 to support a community wide, wireless network that is accessible by additional community resources. Each fire station 118 contains an upgrade radio module with public safety and backhaul transceivers. The radio module can be located anywhere within or on the fire station 118. Cables extend from the upgrade module to antennas located on the fire station to provide connectivity with the network. In this embodiment, the radio module contains a public safety transceiver and a backhaul transceiver. In this embodiment, the public safety network operates at 4.9 GHz and allows additional community resources to access the network. For example, mobile communication devices 164 used by community trusted personnel such as police officers and fire fighters can access the network. Fire trucks 166, parking gate 168 and police vehicle 170 can each access the public safety network. Data on the public safety network can be routed to a backhaul 172. The backhaul then routes data to the internet 174 or to a community control center 176. The various sites supporting the public safety network can be integrated together to form a mesh network or if, for example the network does not cover an entire community, the sites supporting the public safety network can operate independently, routing all traffic to the backhaul. Additionally, the radio modules can be integrated into the power systems of the sites where they are installed. For example, a radio module installed at a fire station 118 can be integrated into the fire station's power system. In the event that power is lost at the station, the station and radio module will operate from that stations backup power supply such as a generator or battery power. Alternatively, the upgrade module can include its own backup power supply such as fuel cells, batteries and solar panels.

The control center 176 can take various forms including the control center described in co-pending U.S. patent application Ser. No. 11/505,642, filed Aug. 17, 2006, entitled “Integrated Municipal Management Console,” which is hereby incorporated by reference in its entirety and for everything that it describes.

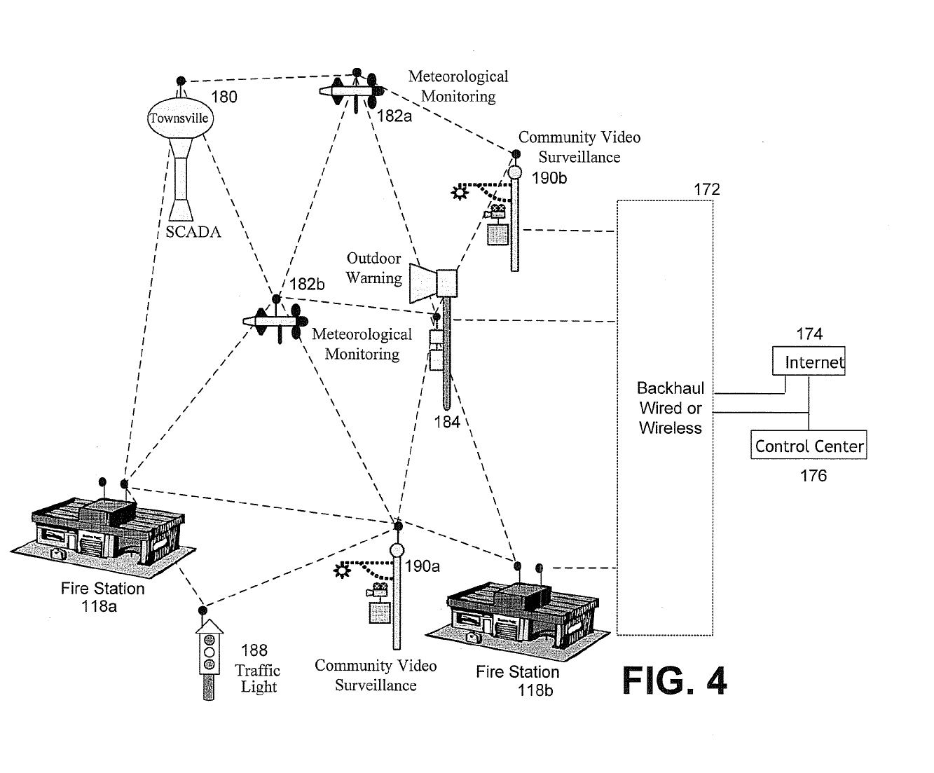

FIG. 4 illustrates various community systems including fire stations and SCADA community warning systems whose infrastructures have been upgraded to provide a community-wide, wireless network in keeping with the process illustrated in FIG. 2. In this embodiment of the invention, various types of community assets operate on a single community-wide mesh network. For example, water system 180, meteorological monitoring stations 182, outdoor warning siren 184, traffic signals 188, community video surveillance equipment 190 and fire stations 118a and 118b all connect to a single network. Allowing these various types of community assets to access a single network simplifies network installation and maintenance, allowing for a more robust network at a lower cost. Data on the network can be routed to the backhaul via wired or wireless network connections. For example, data entering the network node at the video surveillance camera 190b can be routed to the backhaul 172 and then routed to either the internet 174 or control center 176. Embodiments of the invention do not require any particular mix of community assets. For example, one embodiment of the invention is implemented using only the community response system depicted in FIG. 1. However, as illustrated in FIG. 4, any combination of community assets may be used in implementing the process illustrated in FIG. 2.

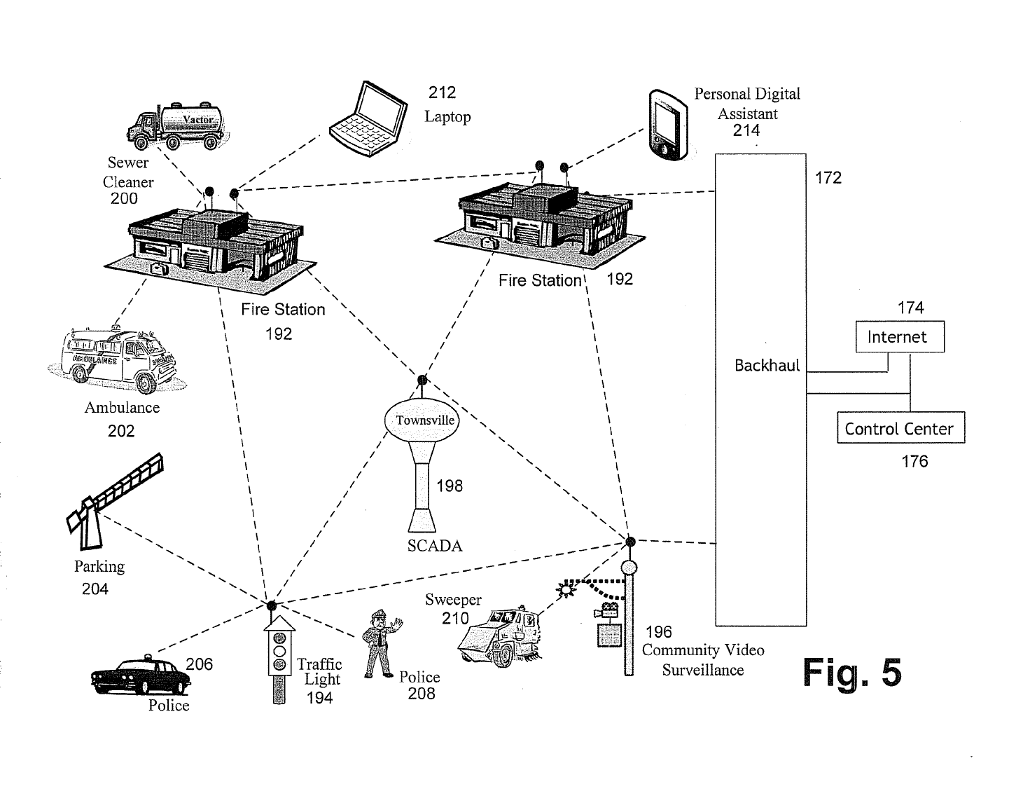

FIG. 5 illustrates typical community resources that may connect to the community-wide, wireless networks of FIGS. 4 and 5. In this embodiment, fire stations 192, traffic light 194, video surveillance system 196 and SCADA water monitoring system 198 form the nodes in a mesh network providing both public access and public safety networks. In creating this network system, the community used the process illustrated in FIG. 2 to install both public safety transceivers and public access transceivers. Sewer cleaner 200, ambulance 202, parking control system 204, police vehicle 206 and sweeper 210 each connect to the public safety network as trusted community resources. Additionally, police officer 208 connects to the public safety network using a handheld radio, personnel digital assistant (PDA) or other mobile device capable of communications as a trusted resource. Trusted resources connected to the public safety network can communicate with the control center 176, the internet 174 or directly with one another using the public safety network. For example, police car 206 located at the scene of an emergency can send information regarding the emergency to ambulance 202 still in route to the scene of the emergency. In this way, trusted resources can efficiently communicate vital information such as video feeds, textual data and audible messages using voice over internet protocol (VoIP). An example implementation of a light bar for emergency vehicles capable of utilizing a public safety network to transmit data, video and voice is described in co-pending U.S. patent application Ser. No. 11/548,209, filed Oct. 10, 2006, entitled “Fully Integrated Light Bar,” which is hereby incorporated by reference in its entirety and for everything that it describes.

However, the nodes illustrated in this embodiment also contain transceivers for public access, allowing the public to connect devices to the public network. For example, laptop 212 and personnel digital assistant 214 each connect to the public access network using Wi-Fi technology. Additional devices such as VoIP phones may also connect to the network. In some embodiments of the invention, any device capable of operating using the correct protocol can connect to the public access network. Data from the trusted resources is routed through the public safety network to the backhaul 172 and then to either the internet 174 or control center 176. Data from the public access devices is routed through the public access network to the backhaul 172 and then to the internet 174. Additional devices can access either the public access network or the public safety network. For example, an all hazard warning device may connect to either network to warn citizens of dangers. An example implementation of an all hazard warning device is described in co-pending U.S. patent application Ser. No. 11/558,802, filed Nov. 10, 2006, entitled “All Hazard Residential Warning System,” which is hereby incorporated by reference in its entirety and for everything that it describes. Some communities may also allow data from the public access network to be routed to the control center 176, for example to alert the control center 176 of possible dangerous conditions in the community.

After various systems and devices connect to the network in FIG. 5, those devices and systems can communicate. For example, using the network, fire station 192 can sound an outdoor warning siren 190 (FIG. 4) if it is connected to the same network. Police vehicle 206 can control traffic lights 194 or send messages to the control center 176, a police station or a fire station 192. A fire truck connected to the network can control certain features of a fire station connected to the network. For example, the fire truck may open the garage doors of the fire station using the network. Additionally, the fire truck may be able to sound outdoor warning sirens connected to the network to warn citizens of an emergency. Therefore, any device or system on the network can be allowed to communicate with and control any other device on the network. However, communities can choose to limit access to certain systems on the network. For example, sweeper 210 may be limited so that it can not control or monitor a SCADA system such as the water supply 198. Communities can therefore provide access to some resources and systems while limiting access to other systems and resources.

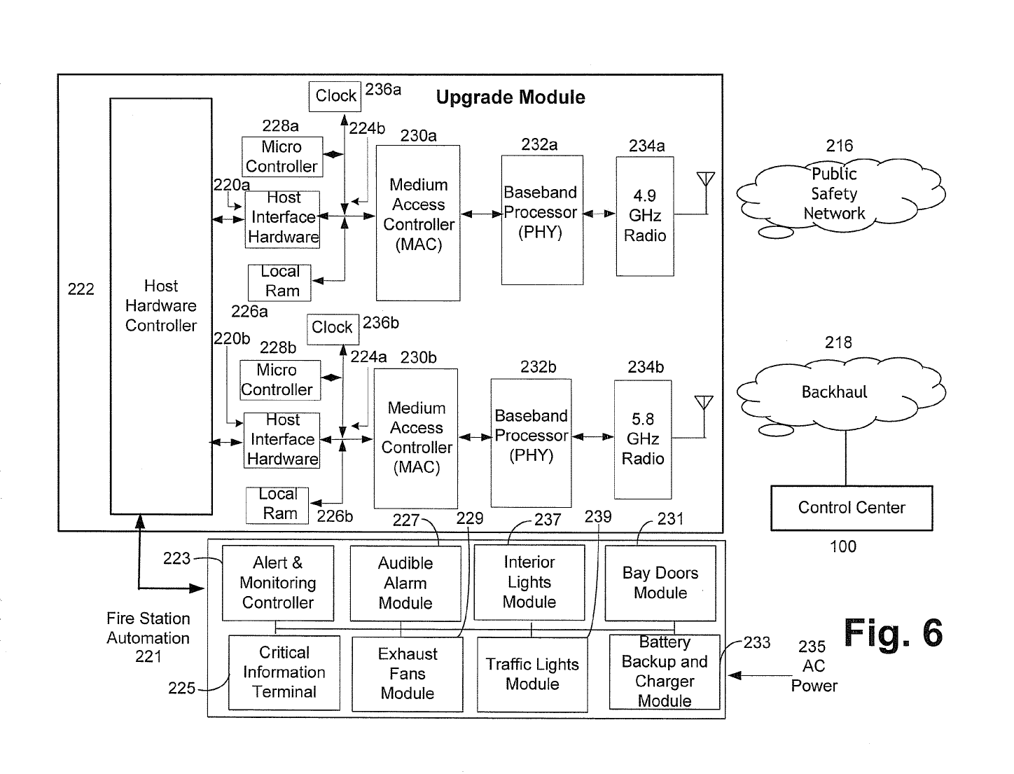

FIG. 6 illustrates one embodiment of a network upgrade module that is retrofitted to upgrade the installed base of the community response system of FIGS. 1 and 3 and the SCADA community warning system of FIG. 4. This embodiment of the upgrade module includes a transceiver to access the public safety network 216 and the backhaul 218. However, other embodiments of the invention use separate modules to implement the public safety transceiver and backhaul transceiver. Any appropriate commercially available or proprietary network adapter may be used. For example, in the embodiment of the invention depicted in FIG. 6, two similar network adaptors are used. The host interface hardware 222 connects to local systems. For example, the host hardware interface can connect to a fire station automation system 221. The automation system 221 includes an alert and monitoring controller 223 and a critical information terminal 225 displaying necessary information such as maps and the type of emergency. An audible alarm module 227, exhaust fans module 229 and bay doors module 231 allow the system to automatically control various features of the station in the event of an alert. Additional features and systems can be integrated into the automation system 221 as needed. For example, inside lights 237 can be turned on to allow fire fighters to see at night, exterior traffic lights 239 or emergency warning lights can be turned on at the road to let approaching vehicles know an emergency vehicle is exiting the fire station. Information regarding the emergency can be automatically printed. Additionally, the system may include a battery backup system 233 that includes a battery charger connected to the power system grid 235. Other backup battery systems can be used such as solar panels and fuel cells.

The host interface hardware 220 also connects to a bus 224. The bus 224 provides the host interface hardware 220 with access to local internal ram 226, an embedded micro-controller 228 and the medium access controller (MAC) 230. The MAC provides the data link layer for connectivity to the network. It sends and receives requests from the physical layer (PHY) 232. The PHY may include an integrated baseband processor. The PHY 232 connects to the radio 234, which transmits and receives wireless signals. A clock 236 controls the radio transceiver. Any suitable radio transceiver may be used to provide network connectivity to the alarm. The transceiver connecting to the public safety network 216 uses a 4.9 GHz radio 234a. Therefore, the exemplary public safety transceiver connects to public safety networks operating in the 4.9 GHz band. The transceiver connecting to the backhaul 218 uses a 5.8 GHz radio 234b. Therefore, the exemplary backhaul transceiver connects to the backhaul operating in the 5.8 GHz band.

Using the upgrade module illustrated in FIG. 6, the control center 100 can issue alerts to the fire station in case of an emergency. For example, a citizen notifies the control center 100 of a fire. The control center 100 sends a signal containing an alert to the backhaul 218 and it is received by the backhaul radio 234b in the upgrade module. After the PHY 232b, MAC 230b and host interface hardware 220b process the signal, the signal passes to the host hardware controller 222. The host hardware controller 222 notifies the fire station automation module 221. The module 221 displays critical information on the terminal 225, sounds an alarm 227, turns on the exhaust fans 229 and opens the bay doors 231. Therefore, fire fighters can quickly respond to the fire. In this example, the fire station acts as a terminal point for the messages.

Similarly, in this embodiment, trusted resources such as the police vehicle 206 (FIG. 5) and fire truck 166 (FIG. 3) connect to the upgrade module through the public safety network 216. The police vehicle or fire truck can send a signal on the public safety network with a message intended for the control center 100. The signal is received by the public safety radio 234a in the upgrade module. After the PHY 232a, MAC 230a and host interface hardware 220a process the signal, the signal passes to the host hardware controller 222. The host hardware controller examines the signal and determines that it is intended for the control center. The host hardware controller passes the signal to the host interface hardware 220b, MAC 230b, PHY 232b and backhaul radio 234b. The radio 234b broadcasts the signal containing the message to the backhaul 218 and the control center 100 receives the message. Conversely, the control center 100 can broadcast a message to the fire truck 166 or the police vehicle 206. The control center broadcasts a signal containing the message to the backhaul 218 and the 5.8 GHz radio 234b receives the message. The PHY 232b, MAC 230b and host interface hardware 220b process the message and it is passed to the host hardware controller 222. The host hardware controller 222 examines the signal and determines that it is intended for fire truck 166 and therefore must be transmitted on the public safety network 216. The signal is sent to host interface hardware 220a, MAC 230a, PHY 232a. The 4.9 GHz radio 234a then transmits the message to the public safety network 216 and it is received by fire truck 166 (FIG. 3).

Additionally, trusted resources, such as a fire truck or police vehicle 206 (FIG. 5) can send information through the upgrade module to other trusted resources, such as another police vehicle or the ambulance 202. The police vehicle or fire truck can send a signal on the public safety network with a message intended for the control center 100. The signal is received by the public safety radio 234a in the upgrade module. After the PHY 232a, MAC 230a and host interface hardware 220a process the signal, the signal passes to the host hardware controller 222. The host hardware controller examines the signal and determines that it is intended for another mobile trusted resource. The signal is sent to host interface hardware 220a, MAC 230a, PHY 232a. The 4.9 GHz radio 234a then transmits the message to the public safety network 216 and it is received by the intended resource, such as the fire truck 166 (FIG. 3). In this example, the upgrade module acts as a router of information from one public safety resource to another public safety resource.

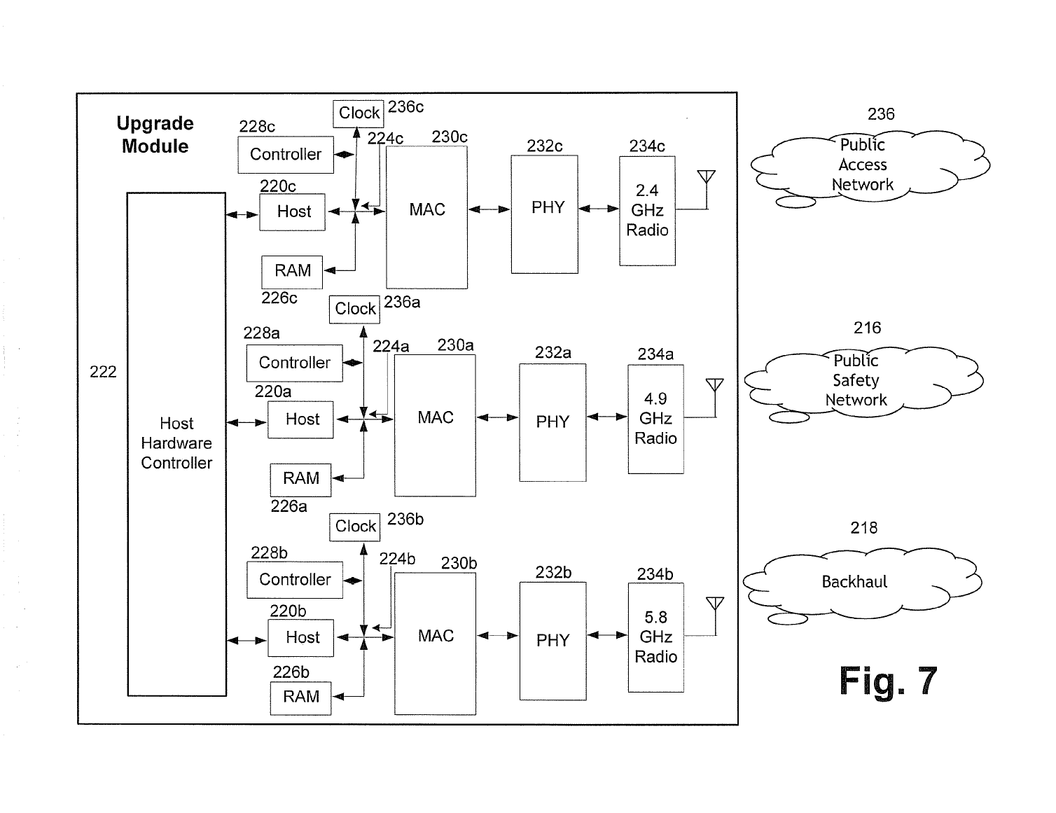

FIG. 7 illustrates another embodiment of a network upgrade module having a Wi-Fi transceiver, a public safety network transceiver and a back-haul transceiver for retrofitting to an installed base of community assets such as the community warning system illustrated in FIG. 1. The transceivers and host hardware interface 222 in FIG. 7 operate similarly to the transceivers in FIG. 6. However, the module depicted in FIG. 7 also accepts public access network traffic. For example, a user can connect a laptop 212 (FIG. 5) to the public access network 236. The public access radio 234c in the upgrade module receives the signal. After the PHY 232c, MAC 230c and host interface hardware 220c process the signal, the signal passes to the host hardware controller 222. The host hardware controller examines the signal and determines that it is intended for the internet. The host hardware controller passes the signal to the host interface hardware 220b, MAC 230b, PHY 232b and backhaul radio 234b. The radio 234b broadcasts the signal containing the message to the backhaul 218 and the internet 174 (FIG. 5) receives the message. Additionally, a community may allow messages to be sent from the public access network to the public safety network. For example, a user at a laptop 212 may send a message through the public safety network to the control center 100 using the upgrade module. Therefore, the user at the laptop 212 can notify the control center 100 of conditions and emergencies in the community.

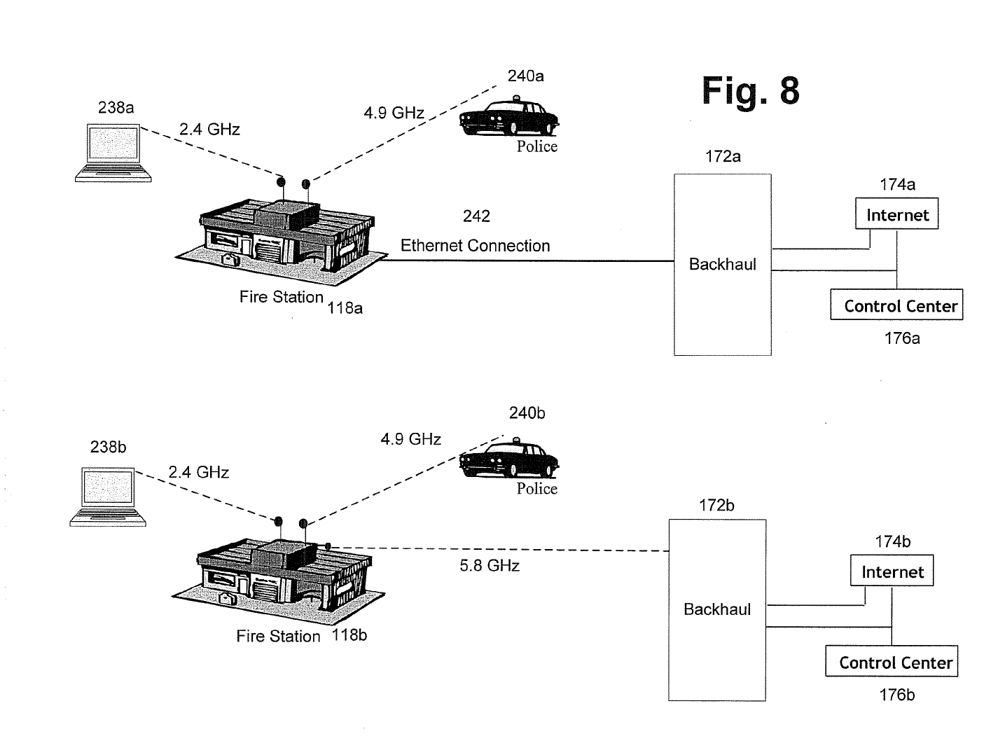

FIG. 8 illustrates various backhaul deployments in the community-wide, wireless network systems illustrated in FIGS. 3 and 4. The community warning system illustrated in FIG. 8 has been upgraded to support a public access network, a public safety network and a backhaul. Fire station 118a connects to laptop 238a through a Wi-Fi public access network operating at 2.4 GHz. Fire station 118a connects to police vehicle 240a using a public safety network operating at 4.9 GHz. A wired Ethernet connection 242 provides access to the backhaul 172a, internet 174a and control center 176a. Similarly, fire station 118b connects to laptop 238b through a Wi-Fi public access network operating at 2.4 GHz. Fire station 118b connects to police vehicle 240b using a public safety network operating at 4.9 GHz. However, fire station 118b connects to the backhaul 172b, internet 174b and control center 176b through a wireless network connection operating at 5.8 GHz.

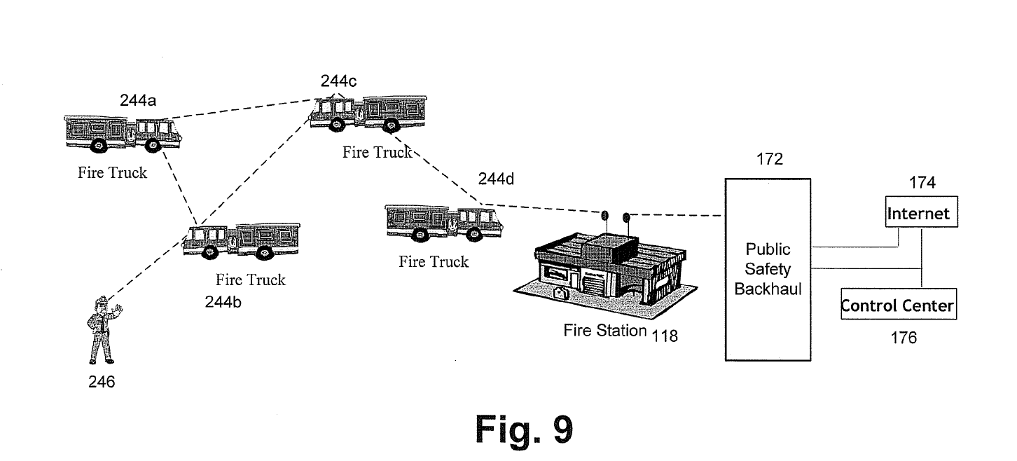

FIG. 9 illustrates a mobile ad hoc network normally supported by the community-wide, wireless network systems illustrated in FIGS. 3 and 4 that effectively patches holes in the network in the event that part of the infrastructure supporting the community-wide, wireless network is lost. If an event partially or completely destroys a community's network infrastructure, first responders and other trusted resources can continue to communicate with the control center and one another by forming an ad hoc network with at least one node also connecting to the community wide network or directly to the control center. Additionally, if an event occurs beyond the range of the community wide network, an ad hoc network can be established to extend the range of the community wide network so that the network reaches the emergency. In this example fire trucks 244 a-d form an ad hoc network to patch a whole in the community wide network. The ad hoc network formed by fire trucks 244 allows other trusted resources to access the network. For example, police officer 246 uses a handheld device to connect to the community wide network through the ad hoc network established by police vehicles 244.

For example, police officer 246 uses a hand held device to send a message to the control center 176. The police officer 246 connects to police vehicle 244b using the public safety network. Police vehicle 244b transmits the message to police vehicle 244c, which transmits the message to police vehicle 244d. Police vehicle 244d uses the public safety network to transmit the message to fire station 118. Fire station 118 transmits the message to the backhaul 172. The control center 176 receives the message from the backhaul 172. In other embodiments of the invention, additional resources are used to form the ad hoc network and any trusted resource can connect to the public safety network through the ad hoc network. An ad hoc network can extend the range of public access networks in addition to public safety networks.

In alternative embodiments, the upgrade process starts by selecting a community-wide network. One example network suitable for upgrading is a Wi-Fi network. In an example implementation, the Wi-Fi network is a community-wide public access mesh network. At any node in the mesh network, public safety resources can be installed. For example, at one node in the network, a security monitoring camera can be installed. At another node in the network, an outdoor warning siren can be installed. Each of the public safety resources may communicate with a control center. In one embodiment, the resources use encrypted messages to communicate using the public access network. Thus, the public access network and the public safety network may operate at the same frequency and use the same network infrastructure, but the public safety network uses encrypted messages. In another embodiment, the public access network is used without encryption. In a preferred embodiment, additional transceivers are installed with the public safety resource to access a public safety network and/or a backhaul network to communicate with the control center.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of extending a wireless network, the method comprising:
upgrading a communications system at one or more of a community's public safety resources to include a node of a wireless network at each of the one or more public safety resources, where the wireless network includes a command center for the emergency response system and each of the nodes functions both as a router of information traveling in the network and a destination for information from the command center to a public safety resource associated with the node;
communicating information from the control center to the one or more public safety resources regarding an emergency situation by way of the wireless network; and
communicating control information to the one or more public safety resources by way of the wireless network for controlling assets owned by the one or more public safety resources.

2. The method of claim 1 wherein the wireless network is a public safety network and the upgrading further includes upgrading the communications system at one or more of the nodes to include a transceiver supporting a public access network.

3. The method of claim 1 including communicating information from at least one of the (1) public safety resource and (2) control center to a trusted resource by way of the wireless network.

4. The method of claim 3 wherein the trusted resource is at least one of a (1) emergency response vehicle and (2) an emergency first responder.

5. The method of claim 1 wherein the public safety resource is at least one of a (1) police station and (2) a fire station.

6. The method of claim 5 wherein the assets are at least one of (1) a garage door, (2) an exhaust fan, (3) an audible alarm, (4) a visual alarm, and (5) a display terminal (6) interior lights (7) external emergency warning lights for traffic (8) printer.

7. The method of claim 1 wherein the upgrading of the communications system includes providing a power source for one or more of the nodes that is local to the node's public safety resource.

8. The method of claim 7 wherein the local power source is one or more of a battery, solar cell and fuel cell.

9. The method of claim 1 wherein one or more of the nodes support wireless communications at 4.9 GHz.

10. A method of installing public safety and public access networks comprising:
upgrading a communications system at a public safety resource to include one or more nodes extending public safety and public access networks, where the communications system provides public safety information to the public safety resource;
sending information over the public safety network to the one or more nodes to control assets owned by the public safety resource;
accessing a remote resource unrelated to the public safety resource by way of the one or more nodes supporting the public access network; and
monitoring at a remote site in the public safety network performance of the assets owned by the public safety resource as the assets respond to the sent information.

11. The method of claim 10 including communicating information to a trusted resource by way of the public safety network from at least one of the (1) public safety resource and (2) a control center remotely located from the public safety resource.

12. The method of claim 11 wherein the trusted resource is at least one of a (1) emergency response vehicle and (2) an emergency first responder.

13. The method of claim 10 wherein the public safety resource is at least one of a (1) police station and (2) a fire station.

14. The method of claim 13 wherein the assets owned by the public safety resource include one or more of (1) a garage door, (2) an exhaust fan, (3) an audible alarm, (4) a visual alarm, (5) a display terminal, (6) interior lights (7) external emergency warning lights for traffic and (8) printer.

15. The method of claim 10 wherein the upgrading of the communications system includes providing a power source for one or more of the nodes that is local to the node's public safety resource.

16. The method of claim 15 wherein the local power source is one or more of a battery, solar cell and fuel cell.

17. The method of claim 10 wherein the communications system is a dedicated communications system in which each node in the system is a terminal able to route information to other nodes of the communications system.

18. A public safety system comprising:
a node at a public safety resource that extends public safety and public access networks to include an area about the public safety resource;
a control center remote from the public safety resource for sending information over the public safety network to the node to control assets owned by the public safety resource;
electronics associated with the node for controlling functions of the assets in accordance with the information from the control center;
a first terminal communicating with the node to send information over the public safety network; and
a second terminal communicating with the node for sending information over the public access network.

19. The public safety system of claim 18 wherein the node is a router and terminal point in the public safety network such that data is routed through the node to other nodes of the public safety network associated with other public safety resources.

20. The public safety system of claim 18 wherein the first terminal includes controls for controlling assets owned by the other public safety resources.
